(19) United States
(12) Patent Application Publication
(10) Pub. No.: US 2017/0257827 A1
(43) Pub. Date: Sep. 7, 2017

(54) WIRELESS COMMUNICATION APPARATUS AND METHOD OF SEARCHING A BASE STATION

(71) Applicant: FUJITSU LIMITED, Kawasaki-shi (JP)

(72) Inventor: Katsuo Nagatomo, Hino (JP)

(73) Assignee: FUJITSU LIMITED, Kawasaki-shi (JP)

(21) Appl. No.: 15/368,970

(22) Filed: Dec. 5, 2016

(30) Foreign Application Priority Data
Mar. 7, 2016 (JP) 2016-043646

(51) Int. Cl. H04W 52/02; H04W 72/04; H04W 4/02

(52) U.S. Cl. CPC H04W 52/0254; H04W 4/027; H04W 72/0453; H04W 72/048

(57) ABSTRACT

A wireless communication apparatus includes a memory and a processor coupled to the memory and configured to perform a search process of searching a base station being to communicate with the wireless communication apparatus, transmit a first radio wave including a first wave pattern when the base station is not detected by the search process, receive a second radio wave, and perform a suppression process of suppressing the search process based on the first wave pattern of the first radio wave and a second wave pattern of the second radio wave.

### CROSS-REFERENCE TO RELATED APPLICATION

This application is based upon and claims the benefit of priority of the prior Japanese Patent Application No. 2016-043646, filed on Mar. 7, 2016, the entire contents of which are incorporated herein by reference.

### FIELD

The embodiments discussed herein are related to a wireless communication apparatus and a method of searching a base station.

### BACKGROUND

With the spread of smartphones, base stations and corresponding bands are added to reduce traffic congestion. Thus, nowadays it is rare for wireless communication terminals, such as smartphones, to be continuously unreachable.

In daily life, however, there are cases where a wireless communication terminal is kept in a locker for a long time in a changing room or the like when a user plays sports or the like or is in a school. Lockers or the like are typically made of metal, the metal blocks radio waves, and wireless communication terminals stored therein are unreachable. In recent years, although it is rare for a wireless communication terminal to be continuously unreachable as the traffic environment, situations where the wireless communication terminal is left in an unreachable environment have occurred.

Typically, a wireless communication terminal, such as a smartphone, in a good radio wave state selects a base station in the best radio wave condition from among a plurality of nearby base stations and becomes coupled thereto. If it is determined that the wireless communication terminal is in an unreachable condition, at which radio waves do not arrive, the terminal repeats a carrier search, which is search processing to search for a base station to be coupled. Therefore, the power consumption when the terminal is in the unreachable condition is higher than that when it is in a good radio wave state.

A recently known technique for suppressing power consumption of a wireless communication terminal is the technique of suppressing power consumption of a cell battery by extending the intervals between initiations of a carrier search of searching for a base station to be coupled in a stepwise manner. For example, in the case where a first carrier search is conducted when the terminal is unreachable and no base station is found, a second carrier search may be conducted after a few time interval. If a base station is still not found, a third carrier search is conducted after a time interval longer than that for the second carrier search.

There is a known technique for suppressing power consumption by suppressing a carrier search by determining whether a wireless communication terminal in an unreachable condition is moving or at rest and, if determining that it is at rest, by stopping power supply to a wireless unit. One example document discussing such related art is Japanese Laid-open Patent Publication No. 10-107718.

### SUMMARY

According to an aspect of the invention, a wireless communication apparatus includes a memory and a processor coupled to the memory and configured to perform a search process of searching a base station being to communicate with the wireless communication apparatus, transmit a first radio wave including a first wave pattern when the base station is not detected by the search process, receive a second radio wave, and perform a suppression process of suppressing the search process based on the first wave pattern of the first radio wave and a second wave pattern of the second radio wave.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an illustration for describing a carrier search in a wireless communication apparatus according to a first embodiment;

FIG. 2 is an illustration for describing an example hardware configuration in the wireless communication apparatus according to the first embodiment;

FIG. 3 is a functional block diagram that illustrates an example functional configuration in the wireless communication apparatus according to the first embodiment;

FIG. 4 is an illustration for describing a band-pass filter;

FIG. 5 is an illustration for describing a relationship between a transmission pattern and a reception level in an unshielded state;

FIG. 6 is an illustration for describing the relationship between the transmission pattern and the reception level in a shielded state; and

FIG. 7 is a flow chart that illustrates the flow of processing.

### DESCRIPTION OF EMBODIMENTS

It is hard to say that the above-described techniques satisfactorily suppress power consumption. Even if power consumption is suppressed, usability is low.

For example, a recent wireless communication terminal may be operable at a plurality of communication modes and conducts a carrier search for each communication mode and for each of frequency bands supported by the communication modes. Accordingly, even when control of extending the time intervals between initiations of a carrier search in a stepwise manner is performed, as the number of frequency bands supported increases, the time desired for the carrier search increases, and this results in an increase in the power desired for the carrier search.

For the technique for suppressing a carrier search while a wireless communication terminal is at rest, in the case where the terminal is left in an environment in which it may become temporarily unreachable because of radio wave congestion, once an unreachable condition has been detected, the terminal is unable to return to a reachable condition unless it is moved. Thus, usability is not good.

Embodiments of a wireless communication apparatus disclosed in the present application are described in detail below based on the drawings. The embodiments do not intend to limit the present disclosure.

### First Embodiment

[Description Of Processing In Wireless Communication Apparatus]

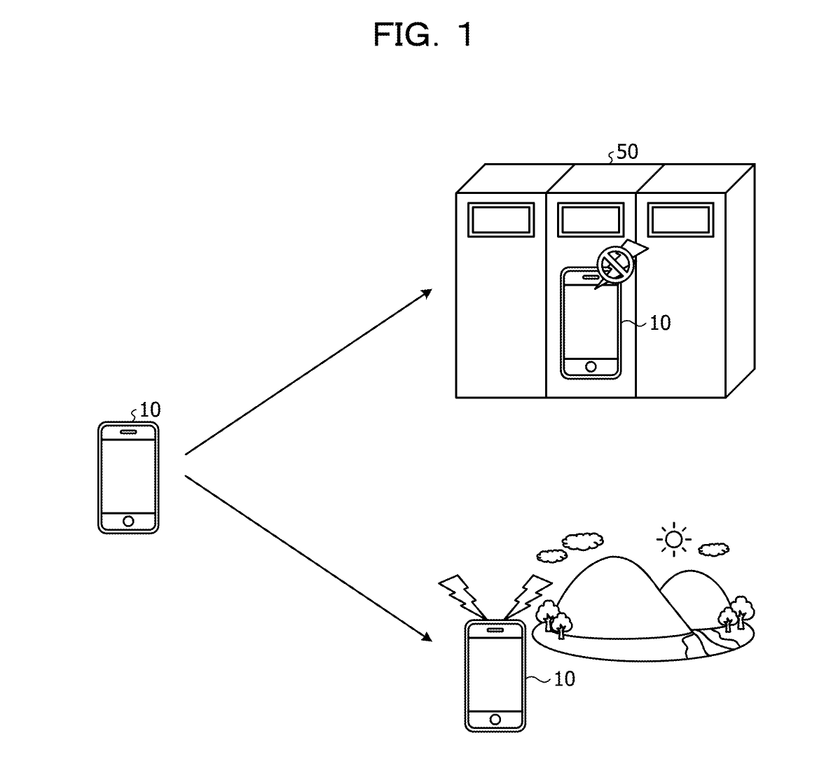

FIG. 1 is an illustration for describing a carrier search in a wireless communication apparatus 10 according to a first embodiment. The wireless communication apparatus 10 illustrated is one example of a mobile terminal, such as a smartphone or cellular phone, and a wireless communication terminal, such as a computer.

One example of the wireless communication apparatus 10 is operable at communication modes, including long term evolution (LTE), wideband code division multiple access ((WCDMA)®), and global system for mobile communications ((GSM)®). The wireless communication apparatus 10 supports a plurality of frequency bands (corresponding bands) for each communication mode. For example, the wireless communication apparatus 10 may support two bands for LTE, three bands for WCDMA, and three bands for GSM.

The wireless communication apparatus 10 in a good radio wave state selects a base station in the best radio wave status from among a plurality of nearby base stations and becomes coupled thereto. If the wireless communication apparatus 10 determines that it is in an unreachable condition, at which radio waves do not arrive, the wireless communication apparatus 10 repeats a carrier search, which is search processing for searching for a base station to be coupled. For example, when the wireless communication apparatus 10 becomes unreachable, it may conduct a carrier search in the order of two bands for LTE, three bands for WCDMA, and three bands for GSM. In other words, when the wireless communication apparatus 10 becomes unreachable, it conducts a carrier search on a total of eight bands in sequence until it becomes able to communicate with a base station, that is, until it becomes reachable.

In the case where it is determined from the carrier search of searching for a base station to be coupled that the wireless communication apparatus 10 is unreachable, the wireless communication apparatus 10 transmits a radio wave with a predetermined transmission pattern and receives the transmitted radio wave. Then, the wireless communication apparatus 10 determines whether it is in a shielded state or not based on the transmission pattern of the transmitted radio wave and the pattern of the reception level of the received radio wave. If the wireless communication apparatus 10 determines that it is in a shielded state, it suppresses the carrier search.

For example, as illustrated in FIG. 1, in the case where the wireless communication apparatus 10 is in a weak radio wave state for a base station in a mountainous region or the like, because it is not in a space shielded by a metal locker 50 or the like, the wireless communication apparatus 10 may conduct a carrier search as usual with the aim of quickly returning to a reachable condition. In contrast, in the case where the wireless communication apparatus 10 is in the space shielded by the metal locker 50 or the like, a radio wave repeats being reflected by the metal locker 50 and does not easily arrive at a region outside the metal locker 50, and is difficult to search for a base station. In that case, the wireless communication apparatus 10 suppresses a carrier search to reduce power consumption until it moves out of the metal locker 50.

As described above, when the wireless communication apparatus 10 becomes unreachable, it transmits a radio wave. When the pattern of the electric field strength of a received radio wave is synchronized with the transmission pattern, the wireless communication apparatus 10 determines that it is in a shielded state and suppresses a normal carrier search. Accordingly, the wireless communication apparatus 10 is capable of suppressing power consumption and also capable of improving usability.

[Hardware Configuration In Wireless Communication Apparatus]

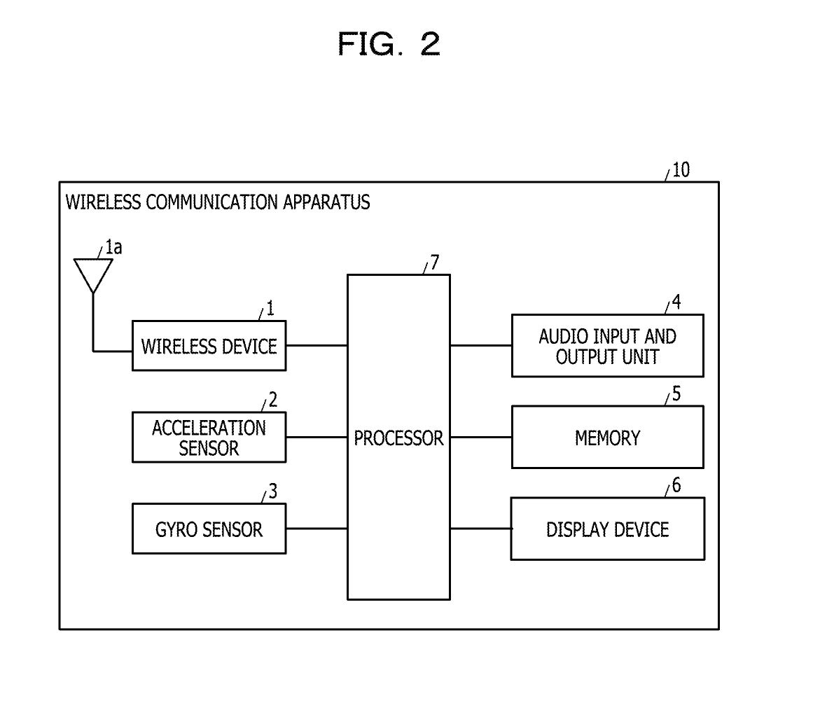

FIG. 2 is an illustration for describing an example hardware configuration in the wireless communication apparatus 10 according to the first embodiment. As illustrated in FIG. 2, the wireless communication apparatus 10 includes a wireless device 1, acceleration sensor 2, gyro sensor 3, audio input and output unit 4, memory 5, display device 6, and processor 7. The illustrated hardware is an example, and other hardware, such as a geomagnetic sensor, may be included.

The wireless device 1 is a device configured to carry out wireless communication by using an antenna 1a. For example, the wireless device 1 may support the above-described communication modes and corresponding bands and control carrier searches and wireless communication.

The acceleration sensor 2 is a sensor configured to detect acceleration of the wireless communication apparatus 10 and to output it to the processor 7 and wireless device 1. For example, a three-axis acceleration sensor may be used as the acceleration sensor 2. The gyro sensor 3 is a sensor configured to detect an angular velocity of the wireless communication apparatus 10 and to output it to the processor 7 and wireless device 1.

The audio input and output unit 4 is a device configured to collect sound through a microphone and to output sound through a speaker. The memory 5 is one example of a storage device and stores data and programs executable by the processor 7. The display device 6 is one example of a display device configured to display various kinds of information and may be a display or touchscreen.

The processor 7 is a processing unit configured to perform the processing in the wireless communication apparatus 10 and may be a central processing unit (CPU). For example, the processor 7 may read a program from a hard disk, develops it in the memory 5, and perform various processes.

[Functional Configuration]

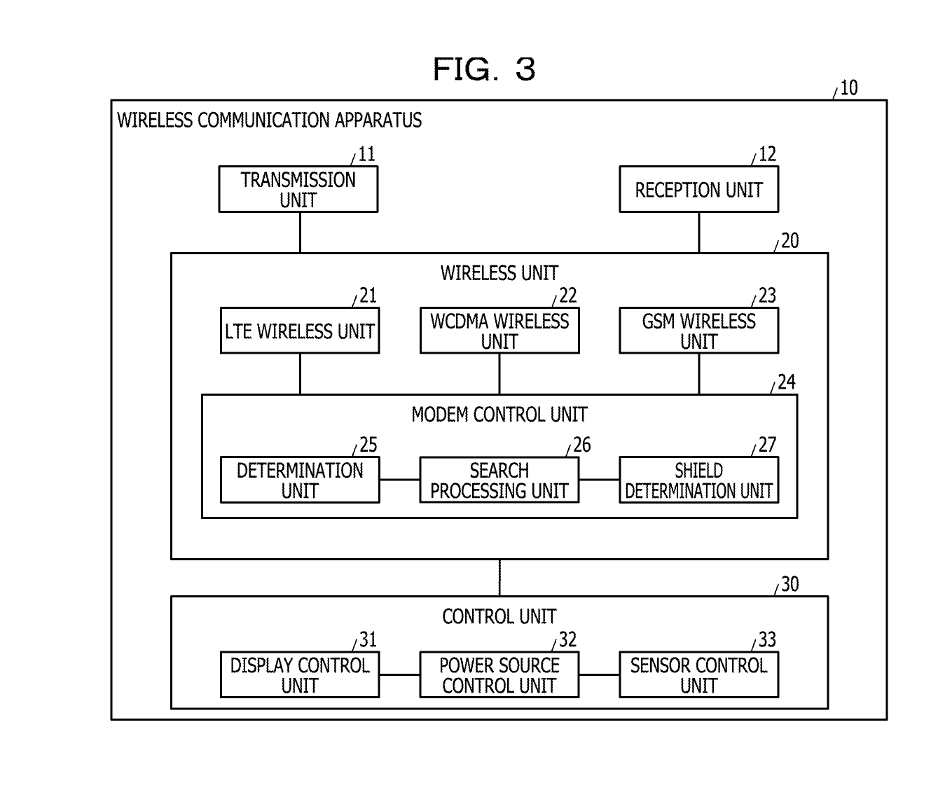

FIG. 3 is a functional block diagram that illustrates an example functional configuration in the wireless communication apparatus 10 according to the first embodiment. As illustrated in FIG. 3, the wireless communication apparatus 10 includes a transmission unit 11, reception unit 12, wireless unit 20, and control unit 30. The illustrated functional units are merely examples, and a storage unit and other units may be included.

The transmission unit 11 includes a plurality of transmission antennas supporting communication modes at which the wireless communication apparatus 10 is operable and a plurality of transmission antennas supporting near field radio communication modes at which the wireless communication apparatus 10 is operable and is a processing unit configured to transmit a radio wave by using the antennas. For example, the transmission unit 11 may transmit a radio wave by using a cellular wireless antenna.

The reception unit 12 includes a plurality of reception antennas supporting communication modes at which the wireless communication apparatus 10 is operable and a plurality of reception antennas supporting near field radio communication modes at which the wireless communication apparatus 10 is operable and is a processing unit configured to receive a radio wave by using the antennas. For example, the reception unit 12 may receive a radio wave by using a cellular wireless antenna.

The wireless unit 20 includes an LTE wireless unit 21, WCDMA wireless unit 22, GSM wireless unit 23, and modem control unit 24 and is a processing unit configured to control wireless communication by using them.

The LTE wireless unit 21 is a processing unit configured to carry out wireless communication by using LTE and transmits and receives radio waves for LTE. The WCDMA wireless unit 22 is a processing unit configured to carry out wireless communication by using WCDMA and transmits and receives radio waves for WCDMA. The GSM wireless unit 23 is a processing unit configured to carry out wireless communication by using GSM and transmits and receives radio waves for GSM.

The wireless communication apparatus 10 uses a frequency band dedicated for each band. To enable simultaneous transmission and reception, a frequency range used in transmission and a frequency range used in reception in the frequency band are different. The wireless unit 20 further includes a band-pass filter with the aim of not allowing radio waves whose frequencies are outside the frequency range used in reception to pass therethrough.

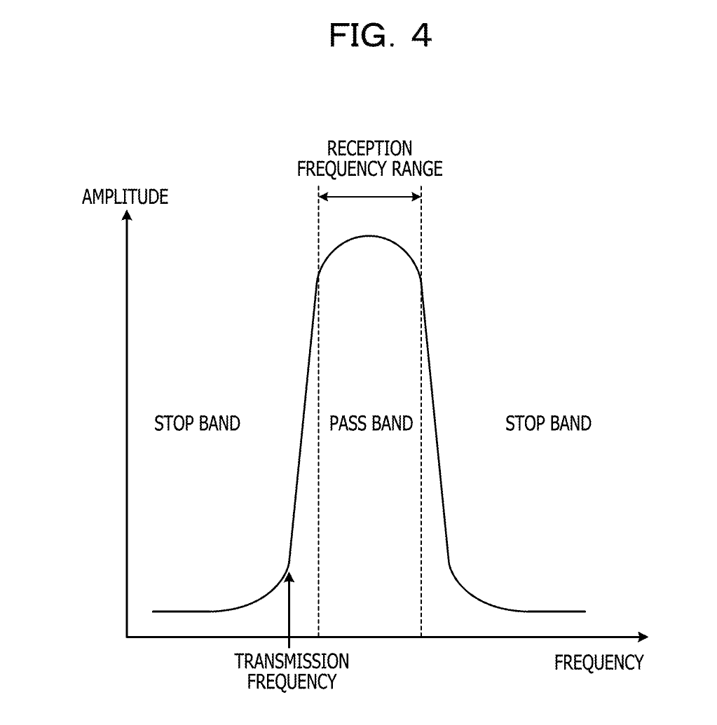

FIG. 4 is an illustration for describing the band-pass filter. As illustrated in FIG. 4, the band-pass filter has stop bands and a pass band and allows radio waves having frequencies within the pass band to pass therethrough. This enables the wireless unit 20 to receive only radio waves having frequencies within a certain range. For example, the frequency range used in transmission and the frequency range used in reception may be near, radio waves having frequencies used in transmission may be unable to easily pass through the band-pass filter, the frequencies may be in the pass band and thus they may not be fully blocked, and a significantly small amount of the radio waves may be allowed to pass in a normal use state, although that significantly small amount would not affect communications.

Referring back to FIG. 3, the modem control unit 24 includes a determination unit 25, search processing unit 26, and shield determination unit 27 and is configured to determine whether the wireless communication apparatus 10 is reachable or unreachable and to control carrier searches. One example of the modem control unit 24 may be an electronic circuit, such as a modem processor.

The determination unit 25 is a processing unit configured to determine whether the radio wave state for the wireless communication apparatus 10 is a reachable or unreachable condition. Specifically, the determination unit 25 determines whether the wireless communication apparatus 10 is reachable or unreachable by substantially the same way as that used in a general mobile telephone or the like. For example, the determination unit 25 determines that the wireless communication apparatus 10 is unreachable in the case where a radio wave is not received from any base station or in the case where only a radio wave at or below a predetermined value level is received, within a fixed time period. When the determination unit 25 determines that the wireless communication apparatus 10 is unreachable, it informs the search processing unit 26 of the unreachable condition.

The search processing unit 26 is a processing unit configured to conduct a carrier search. Specifically, when the determination unit 25 informs the search processing unit 26 of the unreachable condition, the search processing unit 26 conducts a carrier search to search for a base station to which the wireless communication apparatus 10 is able to be coupled. The search processing unit 26 conducts the carrier search until the base station to which the wireless communication apparatus 10 is able to be coupled is found, that is, until the wireless communication apparatus 10 becomes reachable. When the search processing unit 26 finds the base station, the wireless unit 20 carries out normal wireless communication.

The shield determination unit 27 is a processing unit configured to determine whether the wireless communication apparatus 10 in an unreachable condition is in a shielded state and to control a carrier search based on the determination. Specifically, in the case where it is determined that the wireless communication apparatus 10 is unreachable, the shield determination unit 27 transmits a radio wave with a predetermined transmission pattern from the transmission unit 11 and receives a radio wave by using the reception unit 12. The shield determination unit 27 determines whether the wireless communication apparatus 10 is in a shielded state or not based on the transmission pattern of the radio wave and the pattern of the reception level of the received radio wave.

Typically, radio waves have characteristics in which they are reflected and attenuated at a metal surface, and the reflected component has a dominant amount. Accordingly, when a terminal transmits a radio wave in a state where it is surrounded by a metal or the like, the radio wave repeats being reflected in the surround space, and the terminal is allowed to receive the radio wave transmitted by itself. By using such characteristics, the shield determination unit 27 receives the radio wave transmitted from the transmission unit 11 at the reception unit 12 and determines whether the wireless communication apparatus 10 is in a shielded state from the result of the reception.

For example, when the wireless communication apparatus 10 becomes unreachable, the shield determination unit 27 selects one communication mode from among communication modes supported by the wireless communication apparatus 10 and selects one frequency band from among a plurality of frequencies supported in the selected communication mode. In the above-described example, the shield determination unit 27 selects one band from among eight bands. Here, the selected band is one band for LTE.

Then, the shield determination unit 27 transmits a radio wave with a pattern in which the radio wave is transmitted for one second by using the selected LTE, the transmission is suspended for three seconds, and then the radio wave is transmitted for one second. That is, the shield determination unit 27 repeats one second (transmission), three seconds (suspension), one second (transmission), . . . After that, when the electric field strength (dBm) of a received radio wave is synchronized with the transmission pattern, the shield determination unit 27 determines that the wireless communication apparatus 10 is in the shielded state.

For example, in the shielded state, the transmitted radio wave repeats being reflected at the surface of the shielding object and is received by the reception unit 12. As previously described, the amount of a radio wave reflected at the metal surface is dominant, and thus, the electric field strength in the transmission frequency range in the vicinity of the wireless communication apparatus 10 is higher than that in an unshielded state. This leads to an increased level of a signal that passes through the above-described band-pass filter, and as a result, the level of the signal received is higher than that in the unshielded state.

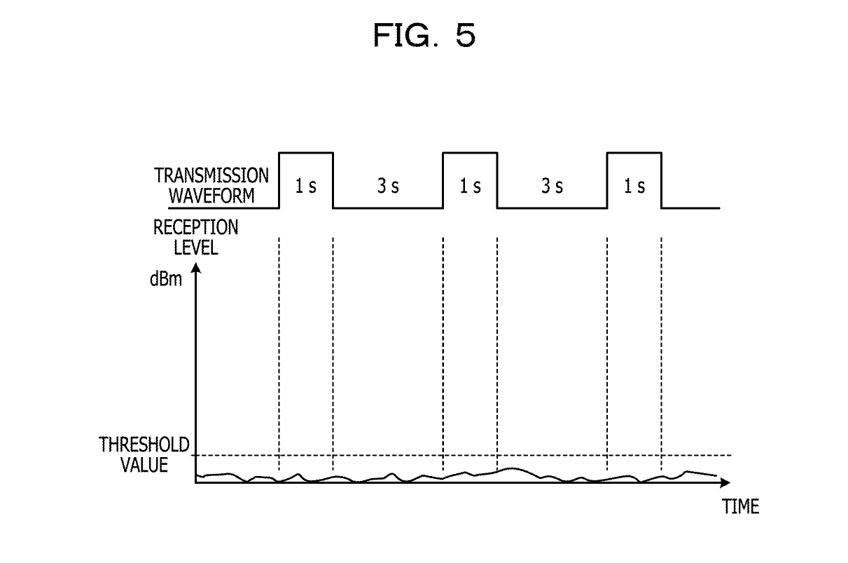

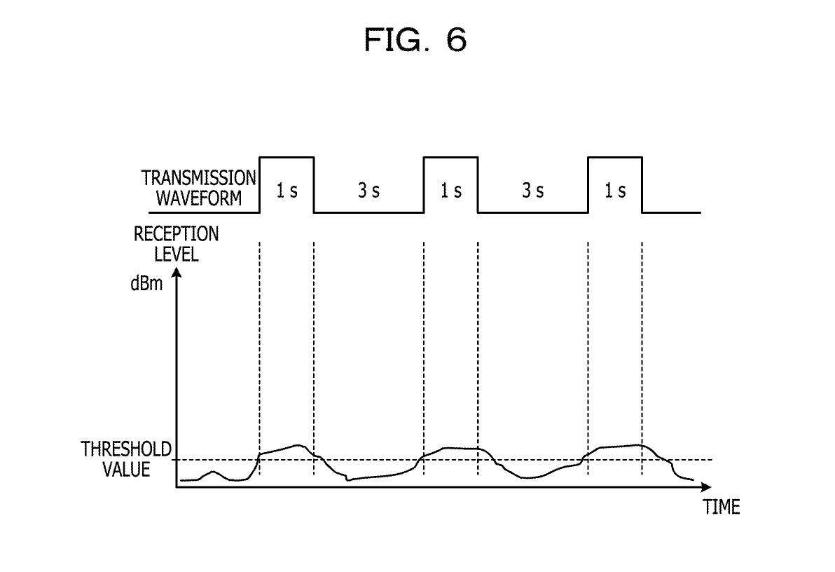

Here, a relationship between the transmission pattern and the reception level is described. FIG. 5 is an illustration for describing the relationship between the transmission pattern and the reception level in an unshielded state. FIG. 6 is an illustration for describing the relationship between the transmission pattern and the reception level in a shielded state. As illustrated in FIG. 5, in the unshielded state, because the radio wave transmitted from the wireless communication apparatus 10 is scattered without being reflected, the reception level (for example, electric field strength) of the radio wave received by the reception unit 12 is continually low and is not synchronized with the transmission pattern (transmission waveform).

In contrast, as illustrated in FIG. 6, in the shielded state, because the radio wave transmitted from the wireless communication apparatus 10 is reflected without being scattered, the reception level (for example, electric field strength) of the radio wave received by the reception unit 12 is synchronized with the transmission pattern (transmission waveform). That is, in the shielded environment, in the case where a radio wave is transmitted, a radio wave with a high level at or above a threshold value is received; in the case where no radio wave is transmitted, the radio wave with the high level at or above the threshold value is not received. In the example illustrated in FIG. 6, the signal level of the received radio wave is at or above the fixed value and thus high for one second for which the radio wave is transmitted, and it is below the fixed value and thus low for three seconds for which no radio wave is transmitted.

Accordingly, the shield determination unit 27 determines that the wireless communication apparatus 10 is in a shielded state when the relationship between the transmission pattern of a radio wave and the change in the reception level of a received radio wave is like the behavior illustrated in FIG. 6 and determines that the wireless communication apparatus 10 is in an unshielded state when that relationship is like the behavior illustrated in FIG. 5.

When the shield determination unit 27 determines that the unreachable wireless communication apparatus 10 in in a shielded state, it provides the search processing unit 26 with an instruction to suppress the entire processing for the carrier search. This causes the search processing unit 26 to suppress the carrier search.

After that, in the case where acceleration at or above a fixed value is detected, the shield determination unit 27 determines again whether the wireless communication apparatus 10 is in a shielded state. At that time, when the shield determination unit 27 determines that the wireless communication apparatus 10 remains in the shielded state, it provides an instruction to suppress the carrier search; when it determines that the wireless communication apparatus 10 in an unshielded state, it provides the search processing unit 26 with an instruction to begin the carrier search. The trigger for determining again whether the wireless communication apparatus 10 is in the shielded state is not limited to the acceleration, and it may be a press on a power button by a user or a touching operation on a touchscreen.

The control unit 30 is an example of an electronic circuit, such as a processor, and includes a display control unit 31, power source control unit 32, and sensor control unit 33. The display control unit 31, power source control unit 32, and sensor control unit 33 are an example of an electronic circuit included in a processor or an example of a process performed by the processor.

The display control unit 31 is a processing unit configured to display various kinds of information on a display section in a display, touchscreen, or the like. The display control unit 31 informs the shield determination unit 27 in the modem control unit 24 that the display section is subjected to a touching operation.

The power source control unit 32 is a processing unit configured to perform various kinds of control relating to the power source. The power source control unit 32 informs the shield determination unit 27 in the modem control unit 24 that the power button is pressed by the user.

The sensor control unit 33 is a processing unit configured to obtain sensor values measured by the acceleration sensor 2 and gyro sensor 3 and informs the processing units of them. For example, the sensor control unit 33 may inform the shield determination unit 27 in the modem control unit 24 of acceleration measured by the acceleration sensor 2.

[Flow of Processing]

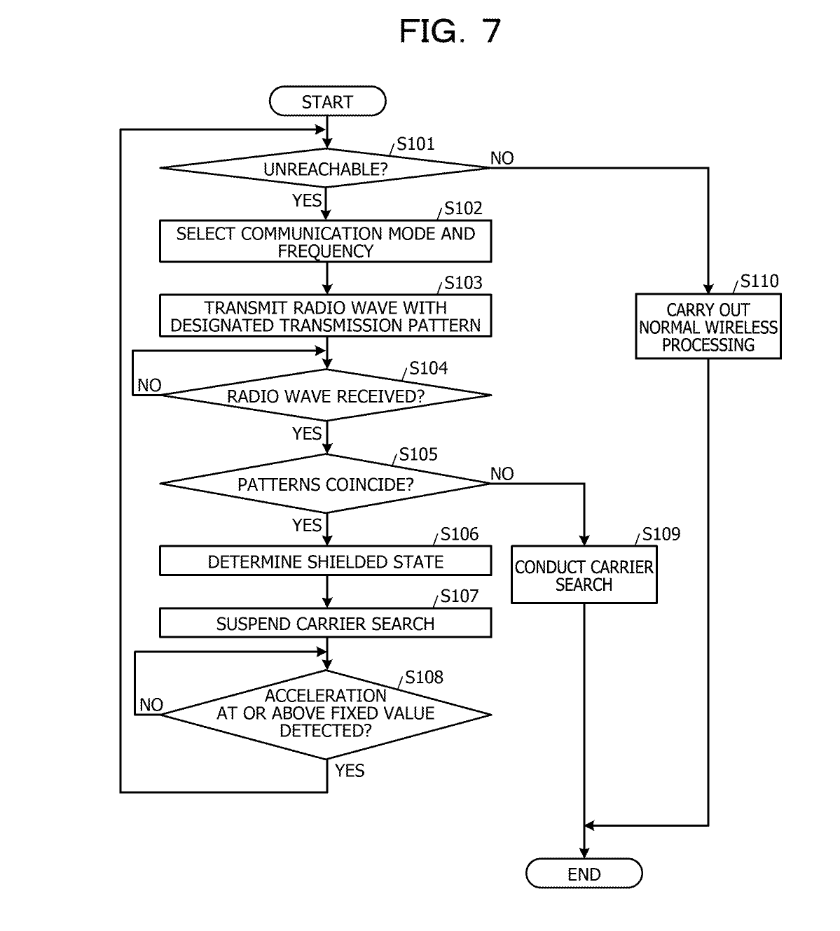

FIG. 7 is a flow chart that illustrates the flow of processing. As illustrated in FIG. 7, when the determination unit 25 detects an unreachable condition (Yes at S101), the shield determination unit 27 selects a communication mode and a frequency band (S102) and transmits a radio wave with a designated transmission pattern (S103).

After that, when a radio wave is received (Yes at S104), the shield determination unit 27 determines whether the transmission pattern and the pattern of the reception level of the received radio wave coincide with each other (S105). When the patterns coincide with each other (Yes at S105), the shield determination unit 27 determines that the wireless communication apparatus 10 is in a shielded state (S106). Then, the shield determination unit 27 suspends the entire processing for the carrier search (S107).

After that, when the shield determination unit 27 detects acceleration at or above a fixed value (Yes at S108), the processing from S101 repeats. The carrier-search suspended state continues until the acceleration at or above the fixed value is detected (No at S108).

When at S105 the shield determination unit 27 determines that the transmission pattern and the pattern of the reception level of the received radio wave do not coincide with each other (No at S105), because the determination indicates that the wireless communication apparatus 10 is in an unshielded state, the search processing unit 26 conducts a carrier search (S109).

When at S101 the determination unit 25 determines that the wireless communication apparatus 10 is reachable (No at S101), the wireless unit 20 carries out normal wireless communication (S110).

[Advantages]

As described above, the wireless communication apparatus 10 is capable of suppressing power consumption in an unreachable condition by suspending a carrier search operation in the unreachable condition, which consumes a lot of power, only when a state in which the wireless communication apparatus 10 is under an environment where it is surrounded with a metal shielding object is detected. When the wireless communication apparatus 10 is not in a shielded state caused by a metal object or the like, it conducts a carrier search even in an unreachable condition. Therefore, even when the wireless communication apparatus 10 becomes temporarily unreachable because of a radio-wave congestion state or the like, if the radio-wave congestion state is removed, it may be quickly coupled to a base station. Hence, the wireless communication apparatus 10 is capable of suppressing the power consumption in an unreachable condition without disadvantage to the user.

Although the wireless communication apparatus is operable at a plurality of communication modes, determination of a shielded state is based on only a single communication mode. Thus, the wireless communication apparatus is capable of more suppressing the power consumption in comparison with the case where normal carrier searches are used.

### Second Embodiment

One embodiment of the present disclosure is described above. The present disclosure may also be carried out in various different forms other than the above-described embodiment.

[Determination Of Shielding]

In the above-described embodiment, an example in which one band for LTE is selected in determination of shielding is described. The present disclosure is not limited to that example. Each of frequency bands in each of frequency multiplex communication modes may be selected. Modes other than the frequency multiplex modes may also be used by measuring and setting a transmission pattern or the like in advance. The above-described transmission pattern is one example. The present disclosure is not limited to the pattern described in the above embodiment. Other transmission patterns, including one in which a radio wave is transmitted at three-second intervals, may also be used.

[Cancellation Operation]

In the above embodiment, the trigger for cancelling the processing of suppressing a carrier search is acceleration, power button, or the like. The present disclosure is not limited to the above-described example. The trigger for cancellation may be other operations. Various operations, including detection of an angular angle at or above a predetermined value, a predetermined button operation, a predetermined swiping operation, and an unlocking operation, may be used.

[System]

The physical configurations of the devices may not be the ones illustrated in FIG. 3. That is, the devices may be distributed or combined in any unit. For example, the search processing unit 26 and shield determination unit 27 may be combined. All or any part of the processing functions performed by the devices may be achieved by a CPU and a program analyzable and executable by the CPU or may be achieved as hardware based on a wired logic.

Of the processing described in the embodiments, all or part of processing described as being performed automatically may be performed manually. Alternatively, all or part of processing described as being performed manually may be performed automatically by a publicly known method. In addition, the processing procedure, control procedure, concrete names, and information including various kinds of data and parameters illustrated in the above description and the drawings may be freely changed unless otherwise specified.

The wireless communication apparatus 10 acts as an information processing apparatus configured to practice a shielding determination method by reading and executing a program. That is, the wireless communication apparatus 10 executes a program that performs substantially the same functions as those of the determination unit 25, search processing unit 26, and shield determination unit 27. Thus, the wireless communication apparatus 10 is capable of performing processes that perform substantially the same functions as those in the determination unit 25, search processing unit 26, and shield determination unit 27. The program in the embodiments is not restricted to being executable by the wireless communication apparatus 10. For example, the present disclosure may also be applied in the case where another computer or server executes the program or in the case where they execute the program in cooperation with each other.

The program may be distributed over a network, such as the Internet. The program may be stored in a computer-readable storage medium, such as a hard disk, flexible disk (FD), compact disk read-only memory (CD-ROM), magneto-optical (MO) disk, or digital versatile disk (DVD), and may be executed by being read from the storage medium by a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication apparatus comprising:
a memory; and
a processor coupled to the memory and configured to:
perform a search process of searching a base station being to communicate with the wireless communication apparatus,
transmit a first radio wave including a first wave pattern when the base station is not detected by the search process,
receive a second radio wave, and
perform a suppression process of suppressing the search process based on the first wave pattern of the first radio wave and a second wave pattern of the second radio wave.

2. The wireless communication apparatus according to claim 1, wherein
the processor is configured to perform the suppression process when there is a correlation between the first wave pattern and the second wave pattern.

3. The wireless communication apparatus according to claim 2, wherein
the processor is configured to perform the suppression process when the first wave pattern and the second wave pattern are synchronized with each other.

4. The wireless communication apparatus according to claim 1, wherein
the processor is configured to stop the search process in the suppression process.

5. The wireless communication apparatus according to claim 1, wherein
the processor is configured to decrease frequency of performing the search process in the suppression process.

6. The wireless communication apparatus according to claim 1, wherein
the processor is further configured to:
select a first communication mode from among a plurality of communication modes used in the search process, and
transmit the first radio wave by using the selected first communication mode.

7. The wireless communication apparatus according to claim 6, wherein
the processor is further configured to:
select a first frequency band from among frequency bands used in the search process, and
transmit the first radio wave by using the selected first communication mode and the selected first frequency band.

8. The wireless communication apparatus according to claim 1, wherein
the processor is further configured to stop the suppression process when acceleration of the wireless communication apparatus is equal to or more than a certain value during the suppression process.

9. The wireless communication apparatus according to claim 1, wherein
the second radio wave includes a reflected element of the first radio wave.

10. A method of searching a base station executed by a wireless communication apparatus, the method comprising:
performing a search process of searching a base station being to communicate with the wireless communication apparatus;
transmitting a first radio wave including a first wave pattern when the base station is not detected by the search process;
receiving a second radio wave; and
performing a suppression process of suppressing the search process based on the first wave pattern of the first radio wave and a second wave pattern of the second radio wave.

11. The method according to claim 10, wherein
in the performing of the suppression process, the suppression process is performed when there is a correlation between the first wave pattern and the second wave pattern.

12. The method according to claim 11, wherein
in the performing of the suppression process, the suppression process is performed when the first wave pattern and the second wave pattern are synchronized with each other.

13. The method according to claim 10, wherein
in the performing of the suppression process, suppression process includes stopping the search process.

14. The method according to claim 10, wherein
in the performing of the suppression process. the suppression process includes decreasing frequency of performing the search process.

15. The method according to claim 10, further comprising:
selecting a first communication mode from among a plurality of communication modes used in the search process, wherein
in the transmitting of the first radio wave, the first radio wave is transmitted using the selected first communication mode.

16. The method according to claim 15, further comprising:
selecting a first frequency band from among frequency bands used in the search process, wherein
in the transmitting of the first radio wave, the first radio wave is transmitted using the selected first communication mode and the selected first frequency band.

17. The method according to claim 10, further comprising:
stopping the suppression process when acceleration of the wireless communication apparatus is equal to or more than a certain value during the suppression process.

18. The method according to claim 10, wherein
the second radio wave includes a reflected element of the first radio wave.
